(19) United States
(12) Patent Application Publication
(10) Pub. No.: US 2011/0004440 A1
(43) Pub. Date: Jan. 6, 2011

(54) PEDOMETER

(75) Inventors: Yuji Asada, Kyoto-shi (JP); Kenji Hashino, Kyoto-shi (JP)

Correspondence Address: OLIFF & BERRIDGE, PLC, P.O. BOX 320850, ALEXANDRIA, VA, 22320-4850, US

(73) Assignee: OMRON HEALTHCARE CO., LTD., Kyoto-shi, Kyoto (JP)

(21) Appl. No.: 12/865,415

(22) PCT Filed: Mar. 16, 2009
(86) PCT No.: PCT/JP2009/055007

§ 371 Date: Jul. 30, 2010

(30) Foreign Application Priority Data
Mar. 18, 2008 (JP) 2008-069093

(51) Int. Cl. G01C 22/00; G06F 15/00

(52) U.S. Cl. 702/160

(57) ABSTRACT

A pedometer of the invention includes an acceleration sensor, and the pedometer is able to switch between a measurement mode in which user's steps are counted based on a waveform obtained from the acceleration sensor and a learning mode in which a criterion used to determine one step in the measurement mode is learned. The pedometer is characterized by including criterion setting means for causing the user to perform learning walking in the learning mode and setting the criterion based on a reference number of steps indicating the number of steps in the learning walking and a reference waveform obtained from the acceleration sensor during the learning walking.

### TECHNICAL FIELD

The present invention relates to a pedometer.

### BACKGROUND ART

Conventionally, there is well known a pedometer including an acceleration sensor. In the pedometer, the acceleration sensor senses a fluctuation in acceleration (waveform; time-series waveform) by walking. The user's steps are counted based on the waveform obtained from the acceleration sensor. Specifically, a threshold (fixed threshold) is previously determined based on amplitudes and periods of sample waveforms obtained from plural persons, and the threshold is used to determine one step. Therefore, there is a problem in that the number of steps cannot accurately be counted for a person having a characteristic manner of walking. Shuffle can be cited as an example of the characteristic manner of walking. Generally, the waveform having the small amplitude and long period tends to be obtained in the shuffle.

From the viewpoint of the problem, for example, there are Patent Documents 1 and 2 as a conventional technique. Patent Document 1 discloses a step counter including a load sensor unit that is disposed in a heel portion of a footwear and a measurement unit that measures the number of steps based on the detection result of the load sensor unit. Patent Document 2 discloses a pedometer that adjusts a threshold (criterion used to determine one step) based on a peak value of an output waveform of the acceleration sensor within a

However, when the pedometer is configures as disclosed in Patent Document 1, it is necessary to wear the pedometer (at least the load sensor unit) in a shoe, which becomes inconvenience for attachment and removal of the pedometer. Further, it is necessary to manually adjust sensitivity of the load sensor unit, which increases a burden of a user. When the pedometer is configures as disclosed in Patent Document 2, the criterion is mistakenly adjusted in mixing a noise in the waveform within the predetermined time.

Patent Document 1: Japanese Unexamined Patent Publication No. 2001-143049

Patent Document 2: Japanese Unexamined Patent Publication No. 2007-148702

### DISCLOSURE OF THE INVENTION

### Problems to be Solved by the Invention

In view of the foregoing, an object of the invention is to provide a pedometer that can accurately set the criterion used to determine one step in a simple manner.

### Means for Solving the Problem

In order to achieve the object, the invention adopts the following configurations.

In accordance with an aspect of the present invention, there is provided a pedometer including an acceleration sensor, the pedometer being able to switch between a measurement mode in which user's steps are counted based on a waveform obtained from the acceleration sensor and a learning mode in which a criterion used to determine one step in the measurement mode is learned, the pedometer characterized by including criterion setting means for causing the user to perform learning walking in the learning mode and setting the criterion based on a reference number of steps indicating the number of steps in the learning walking and a reference waveform obtained from the acceleration sensor during the learning walking.

According to the configuration, because the criterion is set based on the number of steps (reference number of steps) performed by the user in the learning mode and the waveform (reference waveform) obtained from the acceleration sensor by the user's walking, the user can clearly recognize how many steps the obtained waveform is composed of. Therefore, the criterion can be set more accurately, compared with the case in which the criterion is set based on the waveform obtained from the acceleration sensor within the predetermined time (when the criterion is set based on the waveform obtained from the acceleration sensor within the predetermined time, because the user cannot correctly determine how many steps the obtained waveform is composed of, occasionally the criterion is not accurately obtained). Further, the criterion is set by the extremely simple method in which only the user performs the learning walking, so that the burden on the user can be reduced compared with the case in which the user wears the pedometer on the shoe or the case in which the pedometer is manually set. For example, the reference number of steps may be the number of steps that is previously set (stored) in the pedometer or the number of steps that is taught by the user. Any reference number of steps may be used as long as the reference number of steps performed by the user can be defined.

In the above aspect, the criterion setting means divides a period during which the learning walking is performed by the reference number of steps, and the criterion setting means sets the criterion by regarding the waveform in each of the divided periods as a waveform indicating one step. According to the configuration, the waveform in the period divided by the reference number of steps is regarded as the waveform indicating one step, so that the waveform indicating one step can easily be obtained. Therefore, the processing performed by the pedometer can considerably be reduced.

In the above aspect, the criterion includes an amplitude threshold of the waveform obtained from the acceleration sensor, and the criterion setting means determines the threshold based on an amplitude value of the waveform in each of the divided periods. In the above aspect, the criterion includes a period criterion of the waveform obtained from the acceleration sensor, and the criterion setting means determines the period criterion based on a period of the waveform in each of the divided periods. According to the configuration, the criterion of the amplitude or period can be determined based on plural waveforms indicating one step, the criterion can be set more accurately compared with the case in which the criterion is determined based on the whole waveform (when the criterion is determined based on the whole waveform, occasionally how many steps the obtained waveform is composed of cannot correctly be determined. In such cases, the criterion cannot accurately be obtained). In the waveform obtained from the acceleration sensor, because a characteristic of the walking can be expressed by the amplitude or period of the waveform, the optimum criterion can be set according to the walking state by defining the criterion for the amplitude or period.

In the above aspect, the criterion setting means, when the amplitude value of the waveform in the divided period is an outlier, excludes the waveform from waveforms used to determine the threshold. Generally an amplitude value of the noise waveform differs largely from an amplitude value of the walking. Therefore, when the amplitude value of the waveform in the divided period is an outlier, the waveform can be regarded as the waveform including the noise. The criterion that is not affected by the noise can be obtained by excluding the waveform from waveforms used to determine the threshold (criterion).

In the above aspect, the pedometer includes a switch that provides instructions to start and end recording of the reference waveform in the learning mode. Accordingly, the user can perform the learning walking at user's timing. Therefore, the waveform of the reference number of steps can be obtained more correctly compared with the case in which the starting and ending of the recording of the reference waveform are performed in the hasty timing.

In the above aspect, the pedometer includes reference-number setting means for setting the reference number of steps. Accordingly, the user can previously set how many steps the user walks as the learning walking, which allows the learning to be efficiently performed,

In the above aspect, the pedometer includes reference-number informing means for informing of the reference number of steps in the learning mode. Accordingly, the user can recognize how many steps the user walks or how many steps the criterion can be determined.

In the above aspect, the pedometer includes learning-mode informing means for informing of the learning mode in the learning mode. Accordingly, the user can recognize whether the current mode is the learning mode. Therefore, an error of the learning (criterion setting) can be reduced. At least the error that the user mistakes the measurement mode for the learning mode to perform the learning walking can be eliminated by the configuration.

In the above aspect, the pedometer includes processing state informing means for informing whether processing of the criterion setting means is performed. Accordingly, the user can recognize whether the learning (criterion setting) is performed. When the learning is not performed, the information leads to an opportunity that the user performs the learning.

In the above aspect, the pedometer includes criterion storage means for storing a plurality of criteria; and criterion selecting means for selecting one of the plurality of criteria. Accordingly, the criterion can appropriately be used depending on each of the plural walking states. For example, plural persons utilize the pedometer, each person stores the criterion for the walking state thereof in the pedometer, and the person can select the own criterion when utilizing the pedometer. Therefore, the pedometer can efficiently be utilized.

In the above aspect, the pedometer includes transmission means for transmitting measurement result and the criterion used for the measurement in the measurement mode to an external device. Accordingly, the measurement result is widely utilized. For example, the measurement result or the criterion can be expected to be utilized as a factor that recognizes a living condition of the user.

### Effect of the Invention

The invention can provide the pedometer that can accurately set the criterion used to determine one step in the simple manner.

### BRIEF DESCRIPTION OF THE DRAWINGS

FIG. 1 is a view illustrating a waveform that is obtained from an acceleration sensor by general walking.

FIG. 2 is a view illustrating a waveform that is obtained from an acceleration sensor by shuffle.

FIG. 3 is a block diagram illustrating an internal configuration of a pedometer according to an embodiment of the invention.

FIG. 4 is a flowchart illustrating an example of a flow of a learning method.

FIG. 5 is a view illustrating a reference waveform of general walking.

FIG. 6 is a view illustrating a reference waveform of shuffle.

FIG. 7 is a view illustrating a reference waveform including a noise waveform.

FIG. 8 is a view illustrating a specific example of a reference waveform obtained from the acceleration sensor.

FIG. 9 is a view illustrating an example of a reference waveform of obtained from the acceleration sensor.

### BEST MODE FOR CARRYING OUT THE INVENTION

Conventionally, there is well known a pedometer including an acceleration sensor. In the pedometer, the acceleration sensor senses a fluctuation in acceleration (waveform; time-series waveform) by walking. The user's steps are counted based on the waveform obtained from the acceleration sensor. Specifically, a threshold (fixed threshold) is previously determined based on amplitudes and periods of sample waveforms obtained from plural persons, and the threshold is used to determine one step.

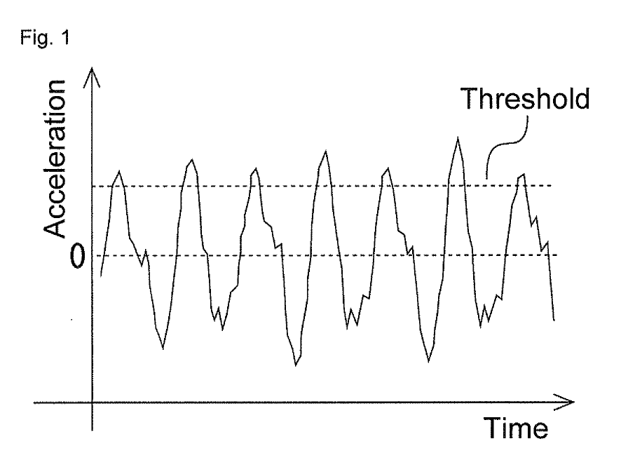

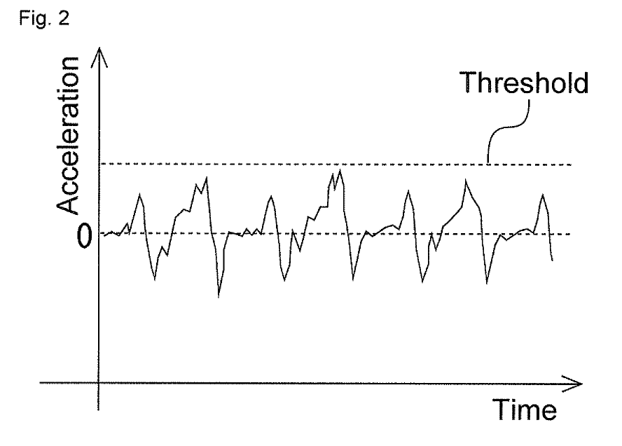

FIGS. 1 and 2 are views illustrating waveforms that are obtained from an acceleration sensor by general walking (manner of walking) and shuffle, respectively. Comparing FIGS. 1 and 2 to each other, in the shuffle waveform, the amplitude is smaller than that of the general walking waveform, and the period is longer than that of the general walking waveform. Usually the fixed threshold is set to an optimum value with respect to the general walking waveform. Therefore, for the characteristic manner of walking like the shuffle, the number of steps cannot accurately be counted.

A pedometer according to an embodiment of the invention can switch between a measurement mode of counting of user's steps and a learning mode of learning of a criterion used to determine one step in the measurement mode, and the pedometer can set the criterion suitable to the user's manner of walking by the learning. Referring to the drawings, the embodiment will be described in detail by way of example.

(Configuration of Pedometer)

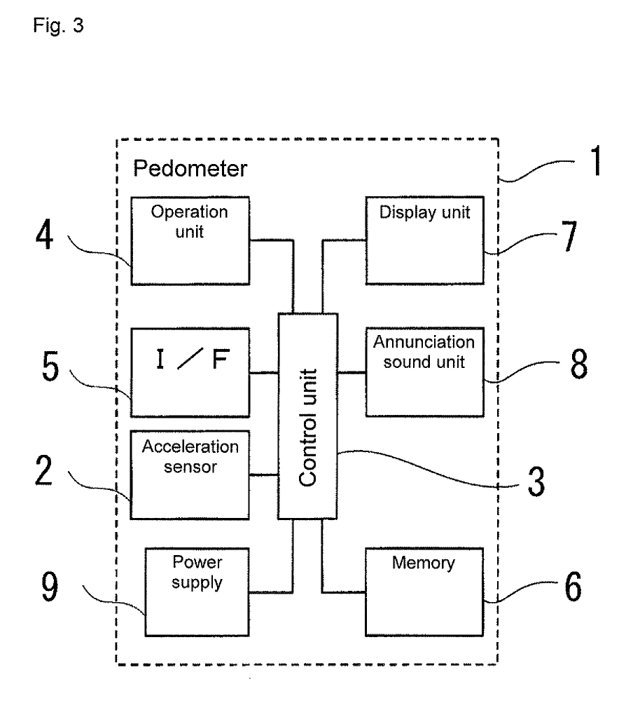

FIG. 3 is a block diagram illustrating an internal configuration of a pedometer 1 of the embodiment. As illustrated in FIG. 3, the pedometer 1 includes an acceleration sensor 2, a control unit 3, operation unit 4, an I/F 5, a memory 6, a display unit 7, annunciation sound unit 8, and a power supply 9.

The acceleration sensor 2 is one that senses acceleration. In the embodiment, the acceleration sensor 2 senses acceleration of physical exertion such as walking and running.

The control unit 3 includes a microcomputer and the like. According to a previously stored program, the control unit 3 takes on a function of performing various pieces of arithmetic processing such as the measurement of the number of steps, the criterion setting, computation of a walking pitch (period) or a stride length, and computation and update of the remaining number of steps to the target number of steps, and the control unit 3 takes on a function of controlling the display unit 7 and the annunciation sound unit 8. The detailed function (criterion setting) of the control unit 3 is described later.

The operation unit 4 is a user interface (such as a switch) that switches between the modes (measurement mode and learning mode) and performs operations such as reset of the number of steps, setting of the target number of steps, and input of various setting values. The I/F 5 is an external interface that transmits and receives data to and from an external device such as a body composition measurement device or a personal computer through wireless communication or wired communication. For example, the I/F 5 transmits the measurement result of the number of steps and the criterion used in the measurement to the external device. The memory 6 is a nonvolatile storage medium in which pieces of data such as various setting values, the number of steps, a target amount of exercise, a remaining exercise time, and information on a user are stored. The display unit 7 is a display means that is formed by an LCD (Liquid Crystal Display) or the like, and pieces of information such as the measured number of steps and the target number of steps. The annunciation sound unit 8 plays operation sound, walking pitch sound, warning sound, and the like based on the control of the control unit 3.

(Learning Mode)

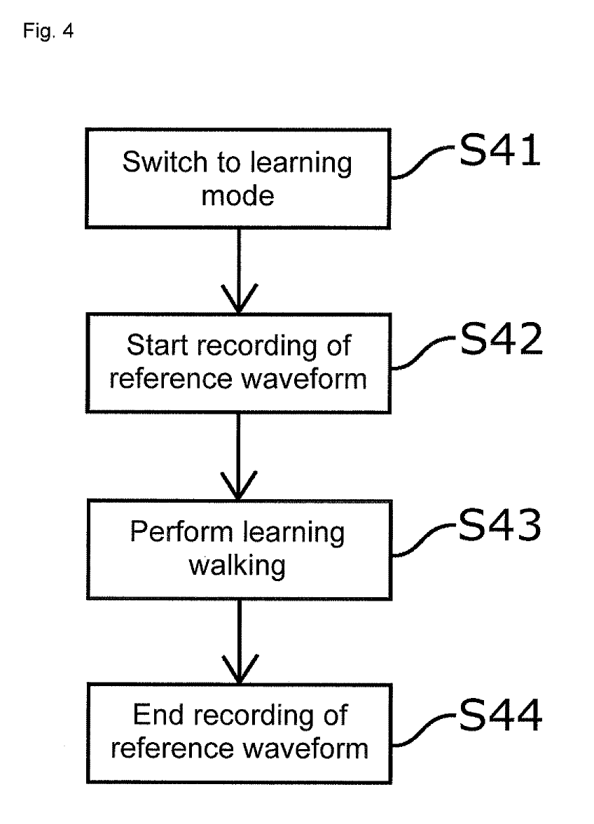

An example of a learning method in the learning mode of the pedometer of the embodiment will be described below with reference to the drawing. In the learning mode, the user is caused to perform learning walking to set the criterion based on the number of steps (reference number of steps) in the learning walking and a waveform (time change in acceleration; reference waveform) obtained from the acceleration sensor 2 during the learning walking. FIG. 4 is a flowchart illustrating an example of a flow of the learning method. In the embodiment, it is assumed that the reference number of steps is previously stored in the memory 6, and the user performs the learning walking of the stored reference number of steps. It is assumed that the user wears the pedometer 1 (for example, around user's waist).

The user switches between the modes of the pedometer 1 to the learning mode with the operation unit 4 (Step S41).

Then the user provides an instruction to start recording of the reference waveform with the operation unit 4 (Step S42).

The user walks by the reference number of steps (for example, five steps) (Step S43).

Then the user provides an instruction to end the recording of the reference waveform with the operation unit 4 (Step S44).

Therefore, the criterion for walking of the user is set.

(Criterion Setting Method 1)

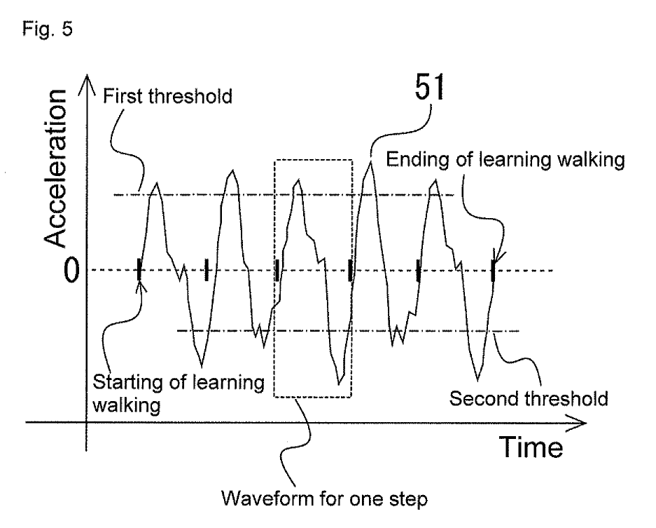

A criterion setting method in the pedometer 1 of the embodiment will be described in detail with reference to the drawing. FIG. 5 is a view illustrating the reference waveform (waveform obtained in Step S43 of FIG. 4) of general walking. The description is made on the assumption that the reference number of steps is set to five steps.

The control unit 3 divides the period during which the learning walking is performed (period of Steps S42 to S44 in FIG. 4) by the reference number of steps. That is, a reference waveform 51 of FIG. 5 is divided in each ⅕ of the whole period. Because the reference waveform 51 is the waveform of the five steps, the waveform (partial waveform) in each divided period can be regarded as the waveform of one step.

The criteria (amplitude threshold and period criterion) are determined based on the amplitude value and period of the waveform in each divided period.

For example, the amplitude threshold is determined based on an average value of maximum values of the partial waveforms or an average value of minimum values of the partial waveforms. In the embodiment, because the average value of the maximum values becomes a positive value while the average value of the minimum values becomes a negative value, 80% of the average value of the maximum values is set to a first threshold, and 80% of the average value of the minimum values is set to a second threshold.

As described above, because the waveform in each divided period can be regarded as the waveform of one step, the divided period can be regarded as the period of one step. Therefore, in the embodiment, the period criterion is determined based on the divided period. Specifically, ±20% of the divided period is set to the period criterion.

In the embodiment, only when the waveform is more than the first threshold while being lower than the second threshold and, at the same time, when the period of the waveform is ±20% of the divided period, the waveform is determined as one step in the measurement mode.

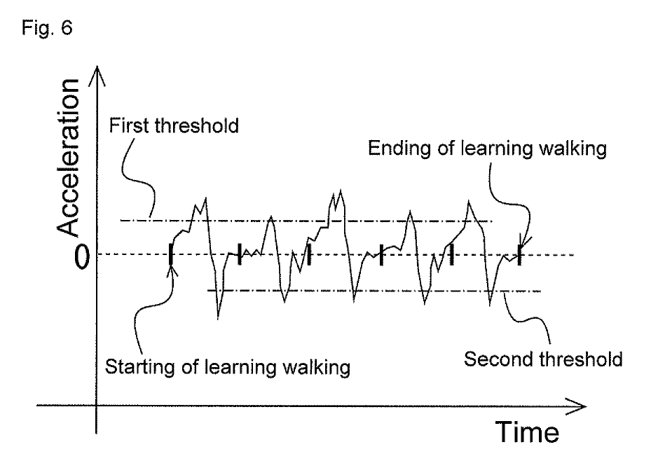

Thus, in the pedometer of the embodiment, the criterion suitable to the manner of walking of the user can be set by performing the learning. For example, even if the manner of walking is the shuffle, only the learning walking is performed to set optimum criterion by a method similar to the above-described method (FIG. 6).

(Criterion Setting Method 2)

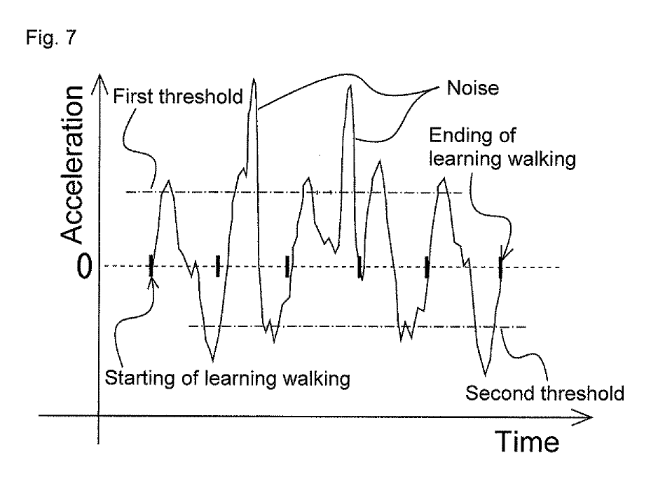

A criterion setting method in a noise mixed case during the recording of the reference waveform will be described in detail. FIG. 7 is a view illustrating a reference waveform including a noise waveform. It is assumed that the reference number of steps is five steps. Only the portion different from that of the criterion setting method 1 is described, and the descriptions of other portions are omitted.

Generally an amplitude value of the noise waveform differs largely from an amplitude value of the walking. Therefore, in the amplitude value of each partial waveform, the amplitude value of the partial waveform including the noise becomes an outlier that deviates from the amplitude values of other partial waveforms. Accordingly, in the embodiment, the partial waveform whose amplitude value becomes the outlier is excluded in determining the amplitude threshold and the like. In the example of FIG. 7, because the amplitude values of the two partial waveforms become the outliers in the five partial waveforms, the threshold is determined based on the three partial waveforms. Therefore, the criterion that is not affected by the noise can be set. As to the method for determining the outlier, for example, the partial waveform having a large variance can be regarded as the outlier in the amplitude values of the partial waveforms.

As described above, in the embodiment, the user clearly recognizes how many steps the obtained waveform is composed of, because the criterion is set based on the reference number of steps and the reference waveform. Therefore, the criterion can accurately be set compared with the criterion that is set based on the waveform obtained from the acceleration sensor within the predetermined time. Further, the criterion is set by the extremely simple method in which only the user performs the learning walking, so that the burden on the user can be reduced compared with the case in which the user wears the pedometer on the shoe or the case in which the pedometer is manually set. In the configuration of the embodiment, the user instructs the starting and ending of the recording of the reference waveform with the operation unit 4 (Steps S42 and S44 of FIG. 4), so that the user can perform the learning walking at user's timing. Therefore, the waveform of the reference number of steps can be obtained more correctly compared with the case in which the starting and ending of the recording of the reference waveform are performed in the hasty timing.

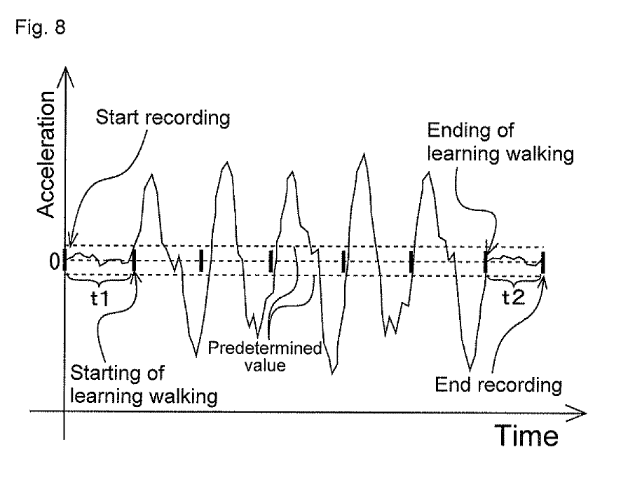

When the learning is actually performed, as illustrated in FIG. 8, the recorded reference waveform includes a waveform that is not related to the walking until the user walks since the recording is started and until the recording is ended since the user ends the walking. Therefore, a period (t1 of FIG. 8) until excess of the waveform over a predetermined value since the starting of the recording and a period (t2 of FIG. 8) until excess of the waveform over the predetermined value before the ending of the recording can be excluded. Therefore, because the obtained waveform includes only the waveform of the walking, the criterion can more accurately be obtained.

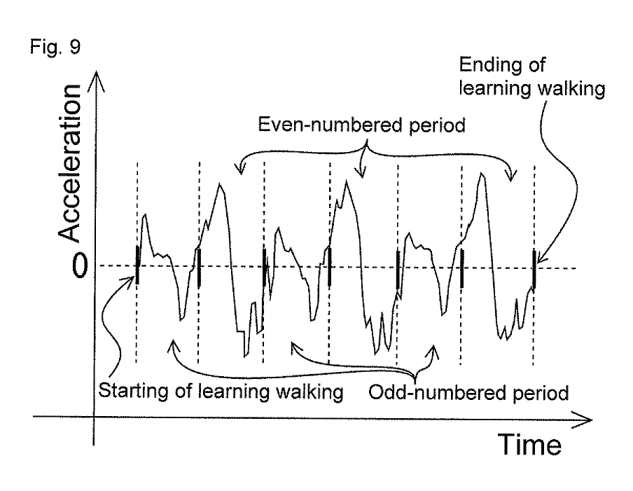

Frequently the user wears the pedometer on one side of user's body (for example, the user puts the pedometer in a right pocket of clothes), and occasionally the waveform obtained by one step of a right foot differs from the waveform obtained by one step of a left foot as illustrated in FIG. 9 (the waveform of FIG. 9 is the reference waveform when the reference number of steps is set to six steps). Therefore, in the divided periods, the criterion may individually be determined based on the even-numbered period and the odd-numbered period (when the period is counted from the recording starting side). In the determination of one step, when the waveform satisfying one of the criteria is obtained after the waveform satisfying the other criterion, one step may be determined with respect to the waveform satisfying one of the criteria.

The amplitude threshold may have either only the first threshold or only the second threshold. It is not always necessary that the first threshold be 80% of the average value of the maximum values. The first threshold may be set to any percent of the average value of the maximum values. The pedometer may be configured such that the user can set the percent of the average value of the maximum values. The same holds true for the second threshold. The amplitude threshold is not limited to the first threshold and the second threshold, any threshold related to the amplitude may be used as the amplitude threshold.

It is not always necessary that the period criterion be ±20% of the divided period. The period criterion may be set to any percent of the divided period. In the embodiment, the whole period of the reference waveform is divided into equal intervals by the number of steps. However, it is not always necessary that the whole period of the reference waveform be divided into equal intervals. In such cases, the period criterion can be determined based on the average value of the divided periods. It is not always necessary that the period criterion be determined based on the divided period. For example, the period is strictly computed by performing waveform analysis of the waveform in the divided period, and the period criterion may be determined based on the computed period. In determining the period criterion, the waveform (divided period) having the large variance may be excluded in the periods obtained by the division or waveform analysis. Any criterion related to the period may be used as the period criterion.

The method for determining one step is not limited to the method of the embodiment (the waveform is determined as one step only when the waveform is more than the first threshold while being lower than the second threshold and, at the same time, when the period is ±20% of the divided period). For example, the waveform may be determined by only one of the first threshold, the second threshold, and the period criterion. The waveform may be determined by comparing magnitude of the amplitude and a difference between the first threshold and the second threshold. Any determination method may be adopted as long as one step can be determined by the method.

In the embodiment, the reference number of steps is previously stored in the memory 6. Alternatively, the user may teach the reference number of steps by manual input or sound before or after the learning walking. The reference number of steps is not limited to five steps. The reference number of steps may appropriately be settable. The user can previously set the reference number of steps, which allows the learning and the measurement to be efficiently performed. The criterion can be obtained with higher accuracy by setting larger than the normal reference number of steps.

In the learning mode, the display unit 7 or the annunciation sound unit 8 may inform the user of the reference number of steps. For example, “the reference number of steps: five steps” and “please walk by five steps” may be displayed on the display unit 7, or the annunciation sound unit 8 may play sound such as “the reference number of steps is five steps” and “please walk by five steps”. Therefore, the user can recognize how many steps the user walks or how many steps the criterion can be determined.

In the learning mode, the display unit 7 or the annunciation sound unit 8 may inform the user of the learning mode. For example, “learning mode” may be displayed on the display unit 7 in the learning mode, or the annunciation sound unit 8 may play sound such as “mode is switched to learning mode” when the mode is switched to the learning mode. “Measurement mode” may be displayed on the display unit 7 in the measurement mode, or the annunciation sound unit 8 may play sound such as “mode is switched to measurement mode” when the mode is switched to the measurement mode. Therefore, the user can recognize whether the current mode is the learning mode, which allows an error of the learning (criterion setting) to be reduced. At least the error that the user mistakes the measurement mode for the learning mode to perform the learning walking can be eliminated by the configuration.

The user may be informed whether the learning (criterion setting) is performed. For example, “learning is already performed” or “criterion exists” may be displayed on the display unit 7. Therefore, the user can recognize whether the learning is performed. When the learning is not performed, the information leads to opportunity that the user performs the learning. The user may be informed of a date when the learning is performed. The opportunity that the user periodically performs the learning can be given to the user by informing the user of the date when the learning is performed.

Plural criteria are stored in the memory 6 or another storage device, and one of the plural criteria may be selected. Therefore, the criterion can appropriately be used according to each of the plural walking states. For example, plural persons utilize the pedometer, each person stores the criterion for the own walking state in the pedometer, and the person can select the own criterion when utilizing the pedometer. Therefore, the pedometer can efficiently be utilized.

### DESCRIPTION OF SYMBOLS

1 pedometer
2 acceleration sensor
3 control unit
4 operation unit
6 memory
7 display unit
8 annunciation sound unit
9 power supply
51 reference waveform

1. A pedometer including an acceleration sensor, the pedometer being able to switch between a measurement mode in which user's steps are counted based on a waveform obtained from the acceleration sensor and a learning mode in which a criterion used to determine one step in the measurement mode is learned,
the pedometer characterized by comprising criterion setting means for causing the user to perform walking of a predetermined reference number of steps in the learning mode and setting the criterion based on the reference number of steps and a reference waveform obtained from the acceleration sensor during the walking of the reference number of steps.

2. The pedometer according to claim 1, wherein the criterion setting means divides a period during which the learning walking is performed by the reference number of steps, and
the criterion setting means sets the criterion by regarding the waveform in each of the divided periods as a waveform indicating one step.

3. The pedometer according to claim 2, wherein the criterion includes an amplitude threshold of the waveform obtained from the acceleration sensor, and
the criterion setting means determines the threshold based on an amplitude value of the waveform in each of the divided periods.

4. The pedometer according to claim 3, wherein the criterion setting means, when the amplitude value of the waveform in the divided period is an outlier, excludes the waveform from waveforms used to determine the threshold.

5. The pedometer as in claim 2, wherein the criterion includes a period criterion of the waveform obtained from the acceleration sensor, and
the criterion setting means determines the period criterion based on a period of the waveform in each of the divided periods.

6. The pedometer as in claim 1, comprising a switch that provides instructions to start and end recording of the reference waveform in the learning mode.

7. The pedometer as in claim 1, comprising reference-number setting means for setting the reference number of steps.

8. The pedometer as in claim 1, comprising reference-number informing means for informing of the reference number of steps in the learning mode.

9. The pedometer as in claim 1, comprising learning-mode informing means for informing of the learning mode in the learning mode.

10. The pedometer as in claim 1, comprising processing state informing means for informing whether processing of the criterion setting means is performed.

11. The pedometer as in claim 1, comprising:
criterion storage means for storing a plurality of criteria; and
criterion selecting means for selecting one of the plurality of criteria.

12. The pedometer as in claim 1, comprising transmission means for transmitting measurement result and the criterion used for the measurement in the measurement mode to an external device.
